(19) United States
(12) Patent Application Publication
(10) Pub. No.: US 2014/0024428 A1
(43) Pub. Date: Jan. 23, 2014

(54) SYSTEM AND METHOD FOR EXECUTING AN INTERACTIVE GAME THROUGH A COMMUNICATION DEVICE IN A NETWORK

(71) Applicants: Jordan Solomon, Toronto (CA); Hans Zou, Scarborough (CA); Herbert Tsui, Markham (CA)

(72) Inventors: Jordan Solomon, Toronto (CA); Hans Zou, Scarborough (CA); Herbert Tsui, Markham (CA)

(21) Appl. No.: 13/946,393

(22) Filed: Jul. 19, 2013

(30) Foreign Application Priority Data
Jul. 19, 2012 (CA) 2783811

(51) Int. Cl. G07F 17/32

(52) U.S. Cl. CPC G07F 17/329
USPC 463/19; 463/25

(57) ABSTRACT

A system and method for processing game sessions of a game having a common playing card is provided where the game sessions are initiated from communication devices in a network. For the system, there is a server and a database. The server is for managing execution of a plurality of game sessions in a game pool for the game accessed by the plurality of communication devices in the network. The server is also for a game session of the game sessions evaluating credentials and restrictions of an account associated with a user of a communication device that initiated the game session; providing a set of numbers to be played for the game session; tracking winning conditions for the game session; tracking a log time for the game session for the communication device; and generating a report of the log time when the game is completed at the communication device. The database is for storing and updating a record of the game session and the log time with records of other game sessions associated with the game sessions.

### FIELD OF THE DISCLOSURE

This disclosure relates to a method and system for managing, executing, controlling, operating and processing a game application through a communication device in a network.

### BACKGROUND

Currently, electronic gaming systems allow users having computers and communications devices play games in an electronic format on the computers where control of the game is managed through a server communicating with the computers and devices.

Such gaming systems have limitations on how revenues can be generated by the game operator and limitations on the game experience provided to the user.

There is a need to provide a system and method for executing a game for a computers and/or communication device to address deficiencies in the prior art.

### SUMMARY OF THE DISCLOSURE

In a first aspect, a system for executing an instance of a game having a playing card in a game session of a plurality of game sessions in a game pool on a communication device through a network is provided. The system comprises: a server for managing execution of the game session for the communication device and a database for storing and updating a record of the game session and the account. The server: evaluates credentials and restrictions of an account associated with the game and with a user of the communication device; provides a set of tokens having values to be played for the game session against the playing card; tracks winning conditions for the game session as the set of tokens is played in the game session; tracks a log time for the game session for the communication device; and generates a report of the log time when the game session is completed at the communication device.

In the system, the server may sequentially provide tokens from the set of tokens to the communication device for the game session.

In the system, the playing card may be distributed through a publication as a printed playing card. In the system, the playing card may be further distributed in an advertisement.

In the system, the game may be Bingo; the values for the set of tokens may be randomly generated numbers; and the playing card may be a Bingo card with numbers to be filled by the generated numbers.

In the system, the game may be a crossword; the values for the set of tokens may be randomly generated letters; and the playing card may be a crossword card with letters to be filled by the generated letters.

In the system, the game may be a tic-tac-toe; the values for the set of tokens may be randomly generated X's and O's; and the playing card may be a tic-tac-toe card with spaces to be filled by the generated X's and O's.

In the system, the log time may be used to track a charge associated with the game session for the account; and the network may be a voice communication network.

In the system, the server may further: generate a graphical user interface (GUI) for entry of game parameters for an administrator of the game, the parameters including templates for the winning conditions; and generate numbers for the playing card, the set of tokens and other sets of tokens for the game pool using parameters of the winning conditions.

In the system, the set of tokens and the other sets of tokens for the game pool may be generated prior to the start of the game.

In the system, a winning condition of the winning conditions is completion of a pattern in the playing card by numbers or letters in the set of tokens.

In the system, the set of tokens may be selected from the plurality of sets of tokens on a random basis.

In the system, the server may further generate a text message to provide the set of tokens to the communication device.

In the system, the server may further send a message to the communication device providing details on the set of tokens to allow the communication device to generate an image of the set of tokens on a display of the communication device.

In the system, the database may further track points associated with the game session in a loyalty point database for the account.

In the system, the playing card may be a common playing card used by a plurality of players.

In a second aspect, a method for executing an instance of a game having a playing card in a game session of a plurality of game sessions in a game pool on a communication device through a network is provided. The method may be executed by a server connected to a communication device through a network, where the server manages execution of the game session for the communication device and the server has access to a database for storing and updating a record of the game session and the account. The method comprises evaluating credentials and restrictions of an account associated with the game and with a user of the communication device; providing a set of tokens having values to be played for the game session against the playing card; tracking winning conditions for the game session as the set of tokens is played in the game session; tracking a log time for the game session for the communication device; and generating a report of the log time when the game session is completed at the communication device.

In the method, the playing card may be distributed through a publication as a printed playing card. In the method, the playing card may be further distributed in an advertisement.

In the method, the game may be Bingo; the values for the set of tokens may be randomly generated numbers; and the playing card may be a Bingo card with numbers to be filled by the generated numbers.

In other aspects various combinations of the above noted aspects are provided.

### BRIEF DESCRIPTION OF THE DRAWINGS

Embodiments of the present disclosure will now be described, by way of example only, with reference to the accompanying drawings, in which:

FIG. 1 is a schematic diagram of elements of a network where users at communication devices access a game application controlled by a server in a network accessed by the communication devices according to an embodiment of the present disclosure;

FIG. 2 is a schematic diagram of a physical game card used as part of the game application executing on the first communication device in the system of FIG. 1 according to an embodiment;

FIG. 3 is a schematic diagram of the second communication device executing the game application in the system of FIG. 1 with a screen of a display of the second communication device a graphical user interface (GUI) showing aspects of an output generated by the game application according to an embodiment;

FIG. 4 is a schematic diagram of a flow chart of the game application executing on the first communication device in the system of FIG. 1 according to an embodiment;

FIG. 5 is a schematic diagram of more details of the flow chart of FIG. 4 according to an embodiment;

FIG. 6 is a schematic diagram of the server managing the game application in the system of FIG. 1;

FIG. 7 is a schematic diagram of a flow chart of an administrative application for the game application executing on the server of FIG. 1 according to an embodiment; and

FIGS. 8a-8e are schematic diagrams of exemplary GUIs generated on a display of the server in processing administrative functions for the game application in the system of FIG. 1.

### DETAILED DESCRIPTION OF EMBODIMENTS

The description which follows and the embodiments described therein are provided by way of illustration of an example or examples of particular embodiments of the principles of the present disclosure. These examples are provided for the purposes of explanation and not limitation of those principles and of the present disclosure. In the description which follows, like parts are marked throughout the specification and the drawings with the same respective reference numerals.

Briefly, an embodiment of the disclosure provides a system, method and device for managing, executing, controlling, operating and processing a game application through a communication device in a network.

An embodiment provides a distributed system and method for playing a game through a game application on a portable electronic device, such as a smart phone. Aspects of the game application are managed by the electronic device. A server that can communicate with the electronic device manages operation of the game application for the device. The server stores, organizes and manages executions of one or more game plays (i.e. instances of games) as executed on the device. The server also manages and tracks administrative functions for the games and the device, e.g. tracking user accounts, with records of wins and losses and managing aspects of the execution of the game including for example, restrictions on play, levels of difficulties and odds for winning for a play. A game play may be linked to a physical or virtual playing card that is distributed and/or is generated separately from the execution of the game play.

Further details of features of an embodiment are now provided. First a description of a system providing an environment where a game application is being executed is provided according to an embodiment. Next, details on a game managed by the game application are provided. Next, details of flow of a game play of the game as executed on a communication device in the system are provided. Finally, details of administrative functions provided by a server managing the game application are provided. Each of the features is described in turn.

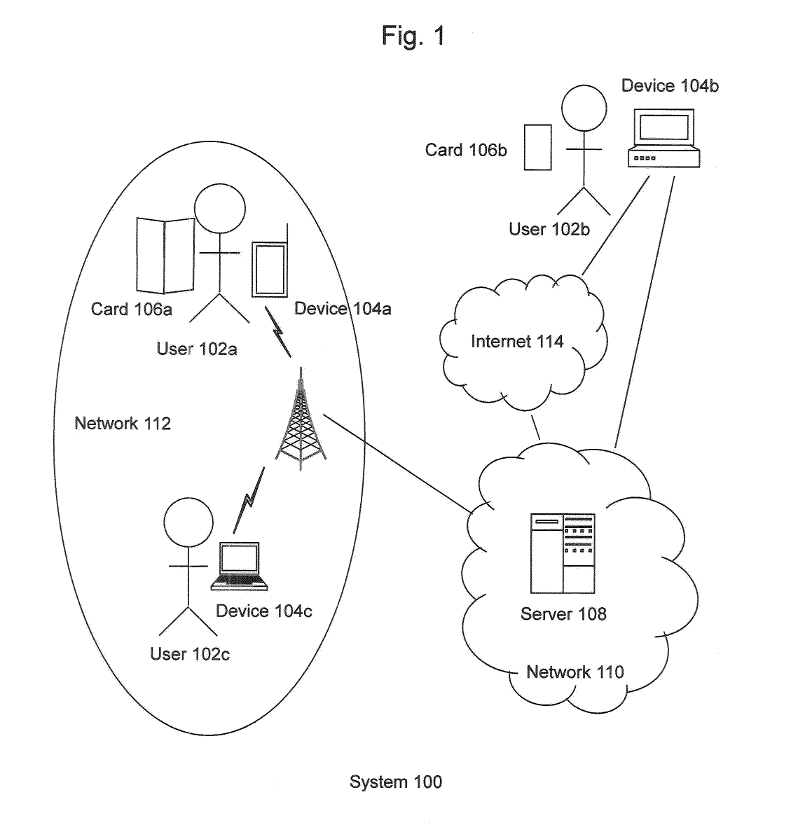

Referring to FIG. 1, details are provided of a system providing an environment where a game application is executed. System 100 shows an environment where a game is being played by users 102 through electronic devices 104. To play the game, some users have access to physical cards 106 that are used to provide a specific “board play” for the game as the game is “played” on their device. Other users can generate virtual board plays on their devices, without the need for a physical card. Server 108 in network 110 provides central management of the game plays for the game applications executed on devices 104. Server 108 communicates with devices 104 through various networks. Network 112 provides a wireless network allowing devices 104a and 104c to communication with each other and to network 110. Internet 112 provides a connection for device 104b to communicate with network 110 and server 108 and other devices and networks (not shown). However device 104b may also have a direct connection to network 110 and server 108.

In one embodiment, a game application operating at a central server (such as server 108) manages a “Bingo” game which can be independently played on one or more devices (such as devices 104). Other games can be managed in other game applications, including solitaire, hangman, Scrabble (trade-mark), crossword, Sudoku, word scramble, tic-tac-toe, roulette and others. For the sake of illustration, features of a Bingo game as provided by an embodiment as described herein.

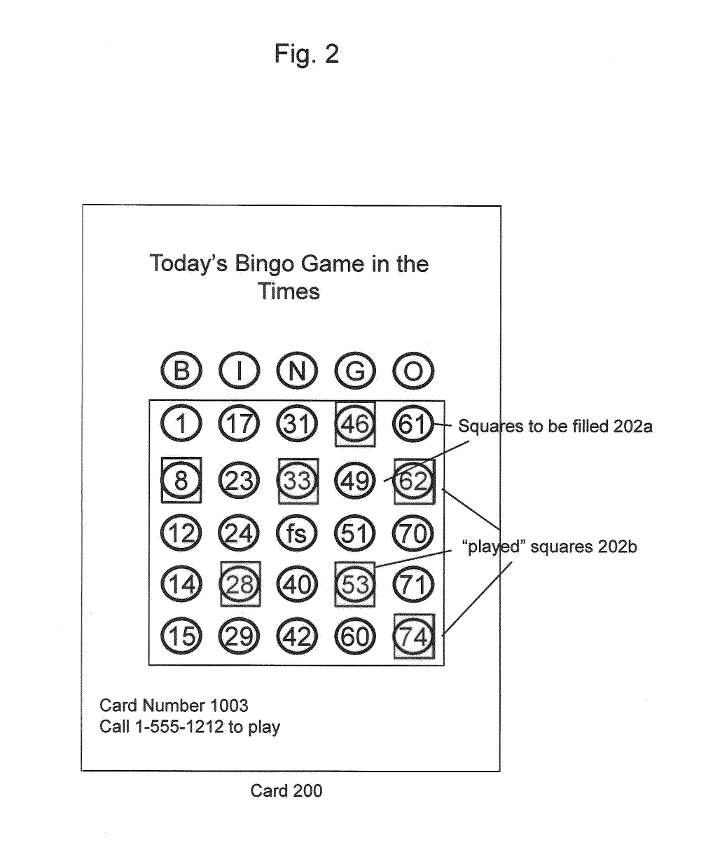

Bingo is a game of chance played with a playing card (or several cards simultaneously). FIG. 2 shows a typical Bingo card. Playing area 200 is a 5×5 grid of squares, where each square contains a number (not shown). By convention, each column in the grid has the successive letters of the word BINGO at its top. Each column (i.e., “B”, “I”, “N”, “G” and “O”) has a series of random, different numbers in non-overlapping ascending ranges. In a typical Bingo card, the ‘B’ column contains five different ascending numbers only between 1 and 15 inclusive; the ‘I’ column contains five different ascending numbers only between 16 and 30; the ‘N’ column contain four different ascending numbers only between 31 and 45; the ‘G’ column contains five different ascending numbers only between 46 and 60; and ‘O’ column contains five different ascending numbers only between 61 and 75. The center spot in the “N” column is typically noted as a “free spot” (“fs”). In a typical game, each Bingo card has a unique same distribution of numbers, but this is not necessarily so. The numbers are typically randomly or pseudo-randomly generated. In card variations, numbers may be provided in non-ascending order and/or may have duplicated numbers. It will be appreciated that other grid sizes and distribution of numbers within the grid can be provided in other variations.

Bingo is played by having each user updating his playing card to track numbers called from a central caller. For the typical Bingo game, the numbers 1 to 75 are sequentially randomly generated and announced. For example the numbers can be randomly selected through a series of numbered balls that are mixed and randomly individually selected. All of the balls may or may not be called. For example a game may be deemed to last for a set of balls (e.g. 30 of the 75 balls will be picked and then the game will be finished). As each number is generated, it is announced to the players and it is marked on a board of called numbers. Once a number is called, it is not placed back in the set of numbers to be called. If the called number is present on a user's game card, then the user marks the entry of that called number in the related square in the grid, typically by marking an “X” or by otherwise blotting out or marking the square of the grid containing the called number. A card is noted as a winning card if the pattern of marked squares matches a recognized winning pattern for the game. Several winning patterns may be provided including, marking of all squares in the card (“a blackout”), marking a complete row or column, marking a predetermined pattern in the card (e.g. all corners marked, a “X”, “T”, “H”, “L”, “1”, “2” . . . “0”, box, etc. across the entire card). The game may continue until a predetermined number of winning cards from the playing audience have been identified (through any combination of winning patterns).

With some features of a Bingo game described, details are provided on a game managed by the game application by an embodiment. Generally, a game has a playing board or playing card (e.g. the Bingo card) with spaces that need to be filled. Rules for the game define the contents of the spaces and how they are filled. An embodiment generates game boards and game plays for the game boards. In one embodiment, the playing card is a common card, where multiple players use the same card, but where each player is provided a separate set of tokens for that player's game to be used against the common playing card. In a game play, one or more tokens are called providing potential matches to the spaces, based on the rules and odds associated with the game. In a representative Bingo game, a token is a randomly generated number between 1 and 75. One embodiment generates sets of randomly generated numbers, where for a given play one set is selected (preferably on a random basis) and each number in the set is called to the player to allow the player to play each number against his Bingo card. The number of tokens called in a set is determined by the administrator of the game. In other embodiments, a token can be a number, a letter, a character or a symbol, following the rules of the related game. For the sake of convenience in describing an embodiment for a Bingo game, the sets of tokens that are generated are simply referred to as sets of numbers. It is understood that a number drawn or selected in a Bingo game embodiment is a specific instance of a token drawn in a general embodiment. In other games, for example, a crossword game, the sets of tokens can contain letters.

As a variation to the typical Bingo game noted above, game cards can be distributed to the public in mass publications, such as in newspapers and/or magazines and/or through advertisements preferably visible in public spaces (e.g. on billboards, buses, bus shelters, streetcars, etc.), per cards 106a and 106b in FIG. 1. In such publications, typically the same game card is printed on the same page. As such different readers who buy copies of the same newspaper (or views the same advertisement) would see the same game card. In other publications one or more different game cards may be printed on separate slip sheets that are inserted into the publication. As such, in a publication card 200 (FIG. 2) may be printed en masse for access by multiple players. Card 200 may have an identification code provided herein (here “1003”) that would enable an embodiment to identify a particular game for that card. In one version of card 200 shows that some of the numbers in the squares are to be filled, shown as squares 202a, with only the center “free spot” filled. In other games, certain other numbers in other squares are pre-filled, shown as squares 202b having a box outline surrounding their numbers to visually distinguish the pre-filled squares 202b from the squares to be filled 202a. Whether or not a game card has pre-filled squares, other visual distinguishers may be provided, using for example, different colours for squares 202a and 202b. The numbers provided in each column may be selected by a random or pseudo random number generator. The selection of the squares to be filled 202a and/or the pre-filled squares 202b may also selected by a random or pseudo random number generator. When multiple players play this game with an embodiment, different players will be provided with separate set(s) of numbers for their individual game sessions for that same card.

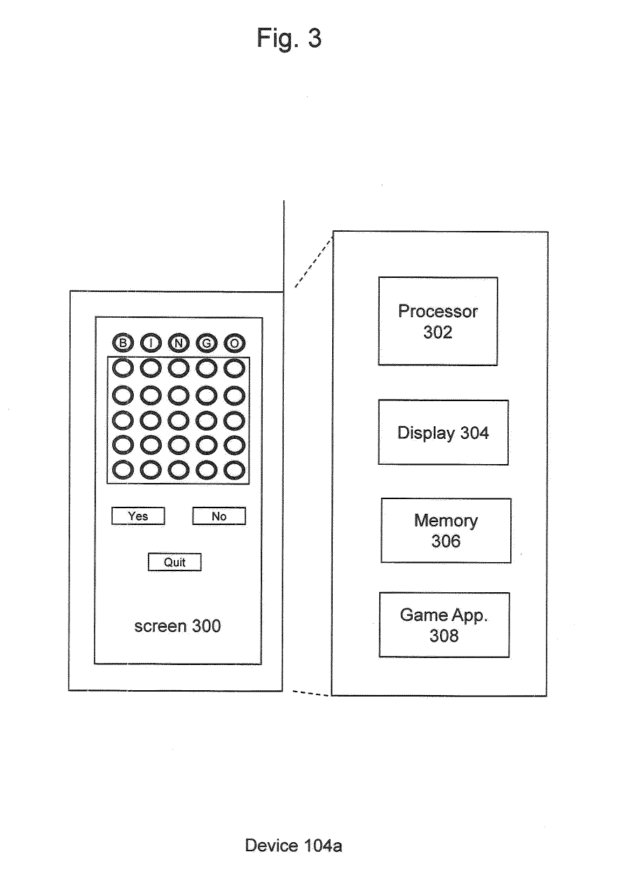

Additionally, cards may be virtually generated, such as on screen 300 on display 304 of device 104 (FIG. 3). Separate identification codes may be provided for virtual cards.

When the same game card(s) are being accessed independently by different users, in order to introduce variations on chances for a first user of winning a Bingo game from a second user accessing the same card, an embodiment provides different, independent game plays to each user. In one embodiment, for each user/game session, a separate set of called numbers is generated and provided for that user for that game session. A game session is one play of a game at a device.

To access the game, a user is expected to have a game card 106 available to her (e.g. through the purchase of a newspaper presenting the game or through other distribution systems for cards, as described earlier). In one embodiment, the user plays a game session of the game by calling the game server through a telephone number associated with the game. In another embodiment, the game session is accessed from communication device 104 by activating a game application operating on communication device 104 (e.g. a landline telephone, mobile phone 104b, smart phone, computer, laptop 104c, tablet, desktop computer 104b etc.). Server 108, in whole or in part, initiates and generates a set of custom random numbers for the user (as tokens for the Bingo card games) and provides them to the user's communication device 104. For a game session, a set of numbers are generated and sequentially provided to device 104. The numbers can be provided through an audio output and/or a visual output on output devices of the communication device. The user can then update her game card as each number in the set is provided to device 104. The user can identify when the card has a winning pattern and send a message to server 108. If the user does not recognize and identify when the card has a winning pattern, server 108 may recognize this condition and may send a message device 104 to notify the user. As such, server 108 can track and verify whether the card has a winning pattern for the game session and provide notifications of prized as applicable. In one embodiment, a game session needs to be completed in its entirety or otherwise terminated for its session. In another embodiment, the user can pause a game session and re-start it at a later instance and/or can start a new game session using a different card (e.g. from the next day's newspaper) or the same card at a later instance. A paused game session may be restarted on the same device 104 or on a different device 104.

In one embodiment, playing a game session of a Bingo game is provided to smartphones, landline telephone, computers and wireless devices 104. Device 104 (as a generic representation of devices 104a-104c) in one embodiment is based on a computing platform having functionality of an enhanced computing device with cellphone and e-mail features. Device 104 is a processor-controlled device (not shown). Software applications operating on device 104 control its operations to implement the above-noted gaming application and communications with the related server.

Referring to FIG. 3, device 104 can be based on construction design and functionality of other electronic devices, such as landline telephones, smart telephones, wireless devices, desktop computers, pagers or laptops having telephony equipment. Device 104 can conduct telephone calls, using any phone system (wireless or otherwise). Exemplary technologies are any known wireless phone systems such as a Mobitex (trade-mark) network, a DataTAC (trade-mark) network, a General Packet Radio Service (GPRS) network and also a variety of voice communication networks, such as Advanced Mobile Phone Service (AMPS), Time Division Multiple Access (TDMA), Code Division Multiple Access (CDMA) system, wireless CDMA, CDMA 2000 system, Cellular Digital Packet Data (CDPD) system, Personal Communication Service (PCS), Global System for Mobile Communication (GSM), Wi-Fi networks, 3GPP Long Term Evolution (LTE) networks, Wireless WAN (IMS), Wireless MAN (Wi-Max or IEEE 802.16), Wireless LAN (IEEE 802.11), Wireless PAN (IEEE 802.15 and Bluetooth), high-speed data packet access (HSDPA) networks, Evolved High Speed Packet Access (HSPA+) networks, and any others that support voice. Device 104 may have other communication technologies, including instant messaging (IM) systems, text messaging (TM) systems and short message service (SMS) systems.

Device 104 has processor 302 therein to execute computer-implemented applications and programs. Processor 302 is connected to all input and output components in device 104 including its keypad, touchscreen, touchpad, microphone, communication modules and others (not shown). Processor 302 may be any processor in the ARM family (trade-mark) from ARM Holdings. Display 304 generates images generated by applications operating on device 104, such as screen 300. Memory 306 is a solid state memory, and includes any combination of RAM, ROM and flash memory modules to store applications and data relating thereto. Game application 308 is an application stored in memory 306 providing instructions to processor 302 to execute instructions, process input and output data and generate screens on display 304 for the game application as described herein.

In FIG. 1, devices 104a and 104c are communicating to wireless network 112. Network 112 is managed by a wireless network operator (e.g. in the United States, AT&T and Verizon are exemplary network providers and in Canada, Rogers Communications, Bell Mobility, Telus Communications, Wind Mobile and others are exemplary network providers). Network 112 maintains accounts for users of devices 104a and 104c (and other devices). Charges to the accounts are based on, in part, usage of airtime of the devices and amount of network bandwidth data consumed by devices 104a and 104c.

As part of a program to enhance a user's experience and loyalty to network 112, the network operator may offer a game application as provided by an embodiment, to be installed and/or executed on devices 104a and 104c in network 112.

The playing of a game in a game session by the user on a device provides a recreational activity for the user and provides revenue streams for the host of the game and managers of a network associated with the device. For an exemplary embodiment, as the game application is executed on device 104, device 104 is maintaining an “airtime” connection through network 112, thereby initiating “airtime” usage fees payable to the network operator for network 112. For an exemplary game, game cards are widely distributed such as through a website, a newspaper, a magazine, a separate game card provided by retailers, an image of a card provided on packaging of retail items, such as candy bars, match books, etc. and other printed materials that can be widely distributed to the public in a relatively low cost manner. An additional revenue stream may be provided by charging such publications/products fees for carrying the printed cards, as the game requires having the card, which requires buying a copy of the publication containing the card. An additional revenue stream may be provided by charging a user to play a game (i.e. a “pay-per-play” system) through a credit card or on his telephone bill. An additional revenue stream may be provided by awarding points, instead of or in addition to prizes, for winning game combinations thereby increasing customer loyalty or customer retention or customer acquisition, and, in return, getting paid a fee for hosting/operating the game. The user would accumulate points to his account as he plays game session(s). Additional points may be provided when a game session is played and a winning condition is met for the card. The points provided to the account may be used for various prizes, awards and products offered by the provider. The loyalty program provides a marketing and client tools to retain current customers and entice new customers to the services provided by the provider. A further revenue stream may be provided by charging for space for advertisers in a section of the card.

An embodiment combines use of a widely distributed card and specific game sessions activated through devices 104 to provide a unique game session where a geographically dispersed group of players can use the same game card (e.g. through the same card printed in a widely distributed newspaper or advertisement or through an electronic distribution to a device), but have individual interactions for different game sessions provided by to the players' devices 104. For network 112, an interactive application is provided on server 108 that is accessed by devices 104a and 104c to execute and manage aspects of a game session for a game, such as a Bingo game described herein. The application may provide interactive voice response (IVR) system and/or DTMF detection features as part of a user interface for the users of devices 104a and 104c.

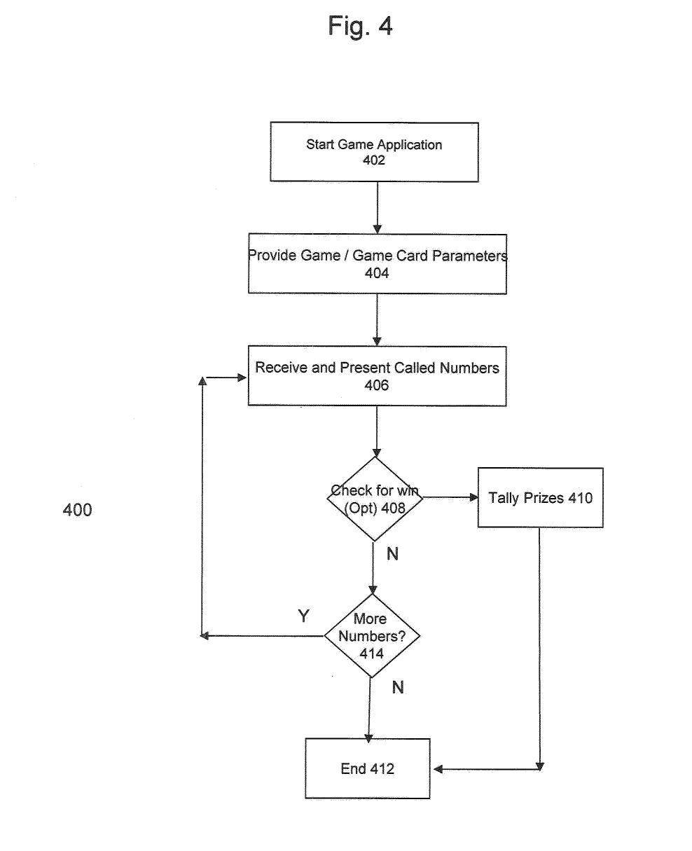

Referring to FIG. 4, aspects of processes executed by a game application of an embodiment operating on device 104 in network 112 communicating with server 108 (FIG. 1) are provided.

At process 402, the game application on device 104 is activated. For the purposes of the description, a “game” is a term used to refer generally to the abstract game itself and a “game session” is a term used to refer to a “playing” of a game on a device (namely the execution of an instance of a game play on the game application). In one embodiment, the application is provided as a voice-enabled application, using communications carried over a voice network in network 112. In such an embodiment, the user at device 104 makes a telephone call to a predetermined telephone number to a server operating the game. When the call is connected to the server, a voice activated response system (operated by server 108) initiates a call during which the game is played out over device 104. Server 108 maintains the call connection, prompts the user at device 104 to provide details of his account and the game to be played, generates numbers for the game, provides the numbers to device 104 and analyzes the numbers and card for winning conditions. At this time, various continuity and access checks can be made by server 108 against the user, device and game session to determine whether a valid session can be started/continued by the user. There may be geographic restrictions for the present location of the user or the related device which may prohibit activation or resuming of the game session. The account for the user may be restricted due to playing limits, age limits, prize limits or other conditions imposed on the user or the related device. Other checks may be conducted before a game session is initiated. For example, a check may be made to determine whether the current player is a customer of the service provider for device 104 (for example AT&T in the U.S. or Rogers in Canada) and whether any payment details need to be verified (e.g. verification of security codes for a credit card account). Back end processes at server 108 manage additional administrative features of the game and accounts. Each call is a game session for a game. A call can have multiple (sequential) game sessions. One or more calls from different devices can be received and processed simultaneously by server 108.

Next, at process 404, the game application makes initial configurations for a game session. A GUI may be generated on display 304 to request that the user provide information about the game card (e.g. a card identification number). In one game scheme, the game is offered as a “pay-per-play” game sessions and the user provides payment information (e.g. a credit card number) to the system. The game session may be a new game session or a resumed session. The system tracks statistics about the game session (such as number of plays, amount of winnings, amount of payments made, location of plays, etc. As part of the IVR, details of the game card are provided via the established call. Data may be entered via the keypad of device 104, providing synthesized DTMF signals (or the like) that can be carried over network 112 to server 108. In another embodiment, a GUI may be generated on a display of device 104 and data provided to the GUI may be extracted and transmitted to server 108.

Next, at process 406, presuming that the game session is approved to be initiated/restarted on device 104, a set of numbers to be called for the Bingo game session is generated or selected from a roster of sets of numbers. The sets of numbers are generated by server 108. Once the set of numbers is generated/selected, each number in the set is sequentially announced on device 104.

In one embodiment, the set of numbers that is provided to a player is determined by a number generating algorithm when the player calls the system to initiate a game session. In one embodiment, the algorithm generates (or already has generated) multiple sets numbers for a Bingo game. For a particular game session, an embodiment selects a set from the multiple sets. The selection is typically made on a random basis. The selection criteria preferably ensure that the selected set has not been used earlier.

For the game session, numbers in the selected set are sequentially announced to the player over the telephone call through a computer generated voice. In one embodiment, a set comprises 30 numbers for a game session.

In another embodiment for the game session, the set of numbers is open. As such, the numbers are individually “fed” (i.e., announced) to the user one after another until the system has fed a winning combination of numbers to the player for the given card. The numbers may be randomly generated or may be selected from a preset list of numbers. In this embodiment, there is a guaranteed winning set of numbers for the card.

The process may check to determine whether the provided numbers in the set complete a winning condition for the game session as the numbers are called. Server 108 may track and may be able to determine when a winning condition is satisfied for a given game. The system may automatically advise the user of the detected winning condition or it may wait for the user to recognize the winning condition. In the latter case, if the user does not acknowledge that a winning condition has been satisfied, the system may or may not advise the user.

It will be seen that when a winning condition is identified for a game session, the session may still have other superior winning conditions associated with that session. For example, as numbers in a session are sequentially provided to device 104, at a first instance for a given card, an initial winning condition of a diagonal line through the free spot (i.e. either a “/” or a “\”) in the card may be established. At this point, it is possible to terminate the session as a winning condition has been satisfied. However, it is also possible that for that session, additional numbers (yet to be called) would provide a second diagonal line transverse the first diagonal line (i.e. either a complementary “\” or a “/” to the first diagonal) so that the two diagonal lines would produce an “X” pattern. This second winning “X” pattern would only be revealed if the user continued with the session even after the first diagonal was revealed. As there is a possibility of having an additional, better, winning condition satisfied if the session is continued, even after an initial winning condition is satisfied, this possibility is a motivation for the user to continue with the session, thereby increasing revenues for the airtime use. The gamble is that the user is hoping to win larger prizes as awarded for the rules of the game. In one game configuration, a prize would be awarded for only the “X” pattern (and not for each individual “\” and “/” line).

If the winning condition is detected (either by the system or by the user), then server 108 confirms the winning numbers, checks the prize table for the current status of payable prizes, updates the prize table and the user's account (including any monetary and loyalty prizes) and provides messages to the user of the results. At this time, continuity and access checks can be made by server 108 against the user, device and game session to determine whether a valid session can be started/continued by the user. For example, there may be geographic restrictions for the present location of the user or the related device which may prohibit activation or resuming of the game. The account for the user may be restricted due to playing limits, age limits, prize limits or other conditions imposed on the user or the related device. A live operator may be contacted and connected to the user to confirm winnings as well. Once playing records are updated, the game session may be terminated; alternatively, the user can be prompted to play another game.

Other algorithms may change a status of whether a winning condition is provided and/or how many numbers are required to produce a winning condition. In one embodiment, the algorithm generates sets of numbers that are not duplicates of recently used sets of numbers (within certain time or playing instances) and that multiple winning combinations are not provided for the same playing same card (e.g. a set of numbers that would provide both a complete row and an “X” pattern on a given card). Other game parameters may permit multiple winning combinations for the same playing same card.

A notable feature of an embodiment provides tools and facilities for building and managing games executed on various devices. Some of the following terms are used in describing how a game is played. In one embodiment, the game is Bingo, although as noted above, other games can be implemented. A game session is the execution of an instance of a particular running of the game on the device. A game pool (or “pool”) is the set of various instances of game sessions that offered to a plurality of devices. An embodiment provides GUI based tools that permit macroscopic construction of playing cards and sets of numbers for a pool. For a Bingo game, a pool is the total sets of numbers that can be played for a given Bingo card. Details are on game sessions and executions of a game session are provided below.

From a game management perspective, one notable issue is accurate determination of playing parameters for game sessions and winning conditions for a given card. An embodiment generates game cards and sets of numbers for the game cards for the pool. The sets of numbers provide, in total, a set of winning numbers and a set of non-winning numbers. The set of winning numbers match the winning conditions that the administrator has programmed for the game pool. In establishing winning parameters for a game pool, the administrator provides to server 108 the number of allowed winning conditions and the numbers of sets that satisfy each winning condition. Once parameters for the game pool are set, the system uses the parameters to identify specific winning sets of numbers, which reflect the total allocation of prizes for the game pool as defined by the parameters.

The odds of satisfying any one of the winning conditions can be set based on the expected number of players, the prize table, the distribution of winning conditions and other factors for the game and game pool.

To enhance game play in a session, in one embodiment, announcement of numbers in the set is provided as an audible statement generated by game application 308 to a speaker of device 104. For example, as a particular number in a set is to be called, a computer generated voice from the server may state an audio statement such as: “The next number in the Bingo game is B 15” or the like for that number. Additionally or alternatively, display 304 may have text/graphics generated thereon that displays the number. For example, game application 308 may send a message to device 104 identifying the next token to be called and device 104 may have a software routine that receives the message and generates text, graphics, sounds and/or animations on an output device of device 104 to report the value of the token. Still additionally or alternatively, server 108 may generate and send a text message to device 104 containing the numbers in the set. The audible statement may be carried and delivered to device 104 using cellular voice services for the user's account for device 104. The text message may be provided using data network services for the user's account for device 104. It will be seen that with interface a user at device 104 is connecting device 104 to network 102 for the duration of the game session. When device 104 is a cellular communication device and network 102 is a cellular network, the network operator gains the fees from such network usages by device 104 for the duration of the game session. An embodiment provides additional tracking of game sessions for an account associated with the games played by a user.

Next, at process 408, as numbers in a set are being presented to the user of device 104 (either through audible statements, text message, graphics or other indicia), an embodiment may make an assessment of the numbers that have been called for the game session and the layout of the numbers from the game card (provided from the card number for the game session). The assessment may be conducted in real time as the game is played or before the game is played. As such, an embodiment can determine whether a winning condition has been met for the card for the game session, in view of the numbers called to date in the current game session. For example, if the last number called completes a match for a line across all columns of game card, and if such a complete line is a complete winning condition (where no further winning conditions can be satisfied with further matches), then an embodiment can recognize this condition and an appropriate message can be provided to the user. The message may be an audible message and/or a text message as noted earlier. A graphic may be generated on a display of device 104 that shows the total numbers called for the game. A “recall” command may be provided to the system to prompt the system to restate the numbers called for the game.

At process 408, a test is conducted to determine if a winning condition is present for the game card. If a winning condition exists, then process 410 is executed, which tallies any prizes associated with the winning condition and provides an announcement to the user at device 104 (either through an audible statement and/or through a text message). The game session may then proceed to end per process 412.

When a winning condition is satisfied or when the series of numbers is fully announced, the number calling process ends. If a winning condition has been recognized (either automatically by the system or through an input provided by the user), the system can then process the winnings for the user's account for the game session. As noted earlier, a game session may have a first winning condition, but if the game session is continued to be played, a second, better winning condition may be revealed. When the game session ends, an audio message that announces game options to the user (e.g. end the game or connect to a live operator to “cash out” prizes) is made. A background process may be initiated to update administrative and tracking data for the account, the game session and the call. In processing the winnings, the system allows the user to take her winnings, see the status of her account (for its money, credit or points value) and/or play again.

If a winning condition was not detected at process 408, then process 414 is executed, which determines whether there are any more numbers to be called in the set. If so, then process 400 returns to process 406 to announce the next number in the set. If not, then process 400 moves to process 412 to end the session.

In another embodiment, once the set of numbers has been announced for the session, if there is no winning condition, the user may be provided with an audible query asking whether the game session is to be continued or a new game session is to be started. If the user response with a positive reply, the algorithm returns to process 406 to generate/select a new set of numbers and announce the next number in the new set for a new game session.

As noted above, when a first winning condition has been identified, the game session may be continued because other winning conditions may also be satisfied by remaining numbers for the game session.

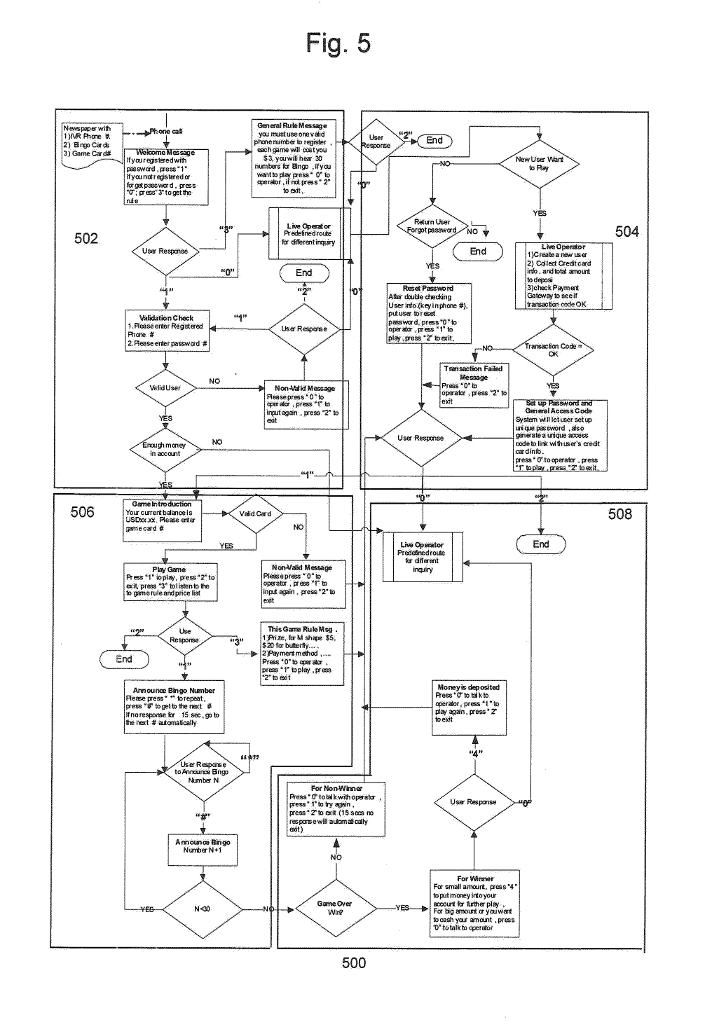

FIG. 5 provides flow chart 500 showing more details of execution of a game session accessed by device 104 as described above for FIG. 4. The game application can be segmented into four main phases; each is described in turn. Phase 502 in an initiation phase where the user activates the application to start the game session on device 104. In this phase a welcome message is generated (either as computer-generated audible text and/or as a message displayed on device 104), which prompts the user to provide responses to various validation and activation checks. From phase 502, if the user is not validated to play the game session, if customer help is needed or if administrative functions need to be accessed, then the application progresses to administrative phase 504. In phase 504, prompts are provided to the user to determine if the user is a new user to the system or if passwords need to be reset.

From phase 504, when administrative details for an account have been established or from phase 502, when the user has been validated to play the game session, the game application proceeds to initiate a game play, per phase 506. In this phase, computer-generated audible text and/or messages displayed on device 104 to introduce the game, provide details of the game session and prompt the user to enter the card number for the card being played. Additional computer-generated audible text/messages are provided on device 104 to provide rules of the game and to prompt the user to start the game session. Once the game session is started, the application selects a set of numbers from the predetermined sets of numbers and sequentially announces each number in the set on device 104 as a computer-generated audible text/message. When all numbers in the set have been announced, the application progresses to termination phase 508, which processes winning and non-winning situations for the just completed (or terminated) game session. Updates are made to the relevant account of the user (to reflect any winning/playing costs associated with the last game session). These updates may include connection time(s) for the game session and any roaming or extraneous data charges associated with the session. Phase 508 may be entered from phase 502, if the user is not validated. Other processes and sub-processes may be provide in each phase.

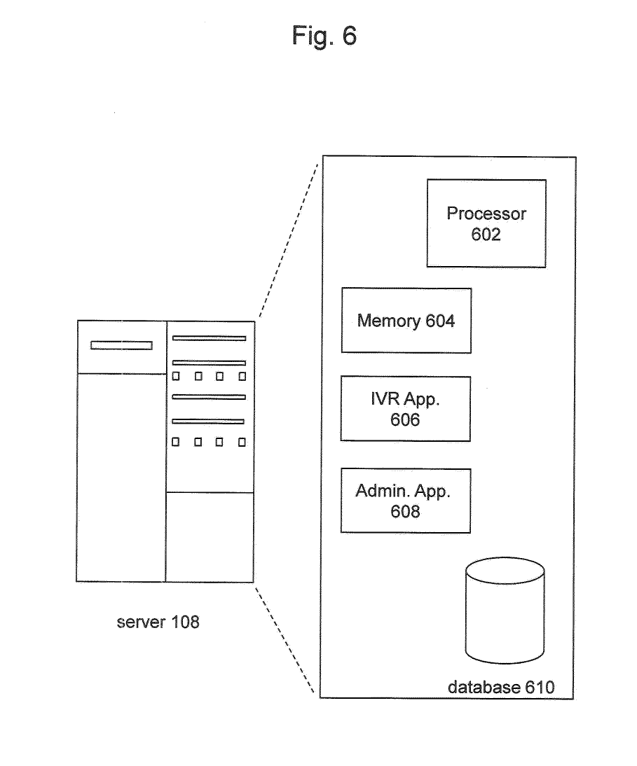

Now, further detail is now provided aspects of managing game applications and server 108. Referring to FIG. 6, server 108 provides an embodiment of the IVR module accessed by device 104 to implement a game application. Server 108 has processor 602 therein to execute computer-implemented applications and programs. Processor 602 is connected to all input and output components in server 108 communication modules and others (not shown). As an example, processor 602 may be any processor from Intel Corporation. Memory 604 is a solid state memory, and includes any combination of RAM, ROM and flash memory modules to store applications and data relating thereto. IVR app. 606 is an application stored in memory 604 providing instructions to processor 602 to execute instructions, process input and output data and generate messages and statements during a game play while device 104 is in a voice call with server 108. Administrative application (admin. app.) 608 is an application stored in memory 604 providing instructions to processor 602 to execute instructions, process input and output data and generate reports relating to all accounts and devices tracked by server 108 in execution of IVR app. 606. Additional applications for other embodiments, such as the server-side application game application for an alternative embodiment mentioned earlier (not shown) can be provided as an application stored in memory 604. Database 610, which may be internal or external to server 108, stores data relating to accounts, users, games and devices for server 108.

As noted server 108 also provides administrative functions for IVR app. 606 through admin. app. 608. Admin. app. 608 may also support and update information on games provided by other gaming applications, such as a server-side gaming application noted above.

Briefly, admin. app. 608 provides an interface to access and update data relating to accounts, users, games and devices generated and processed by server 108. Admin. app. 608 also generates a GUI for a display associated with server 108 to allow an administrator to access data and parameters about accounts, users, games and devices by the games.

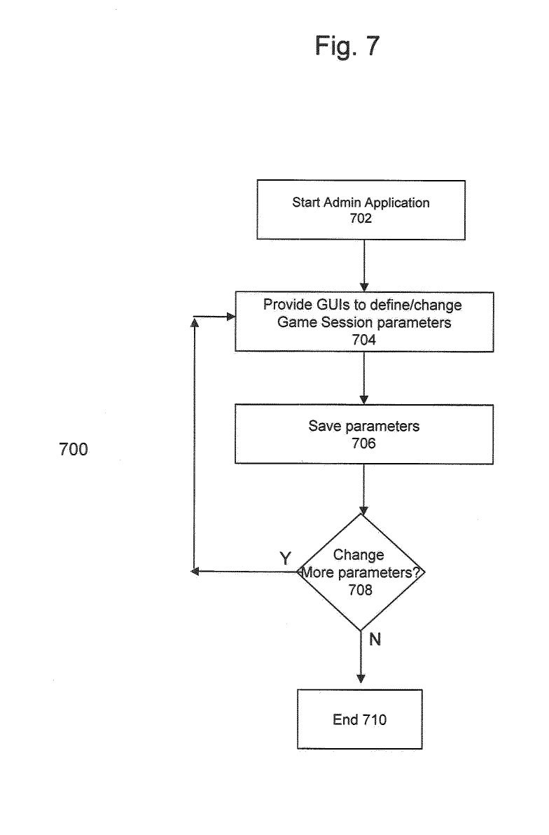

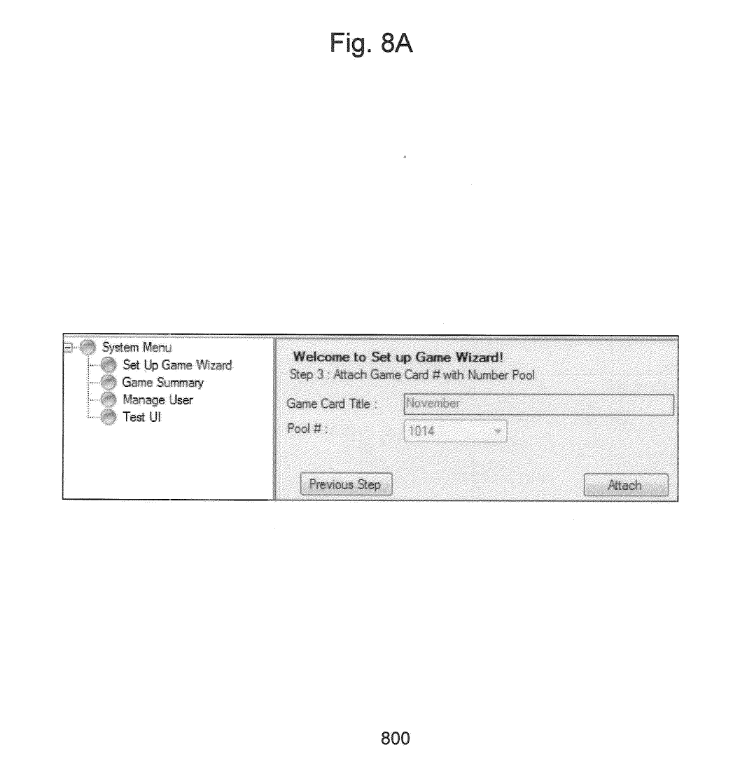

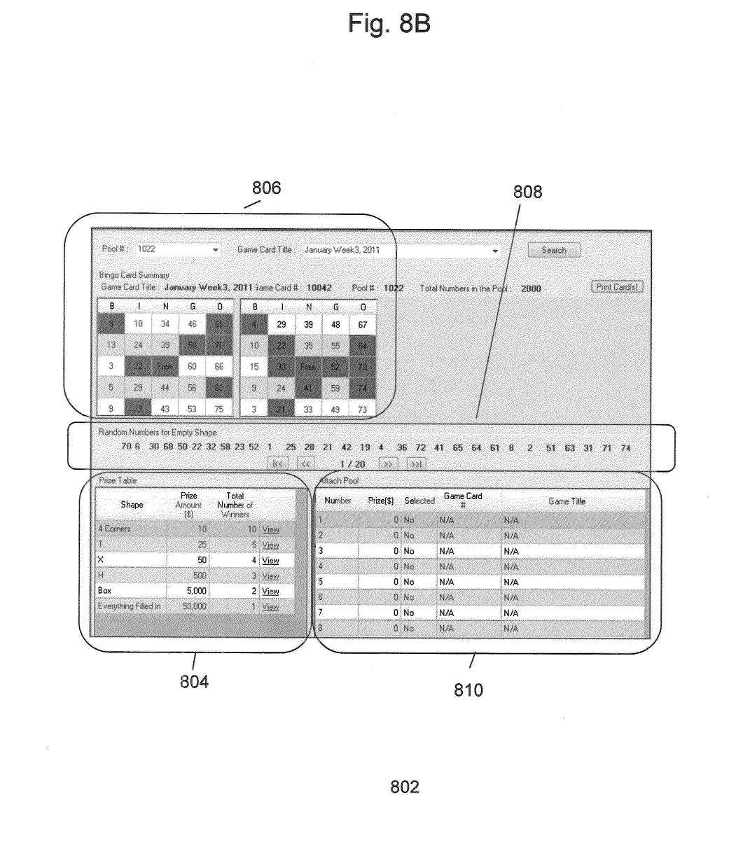

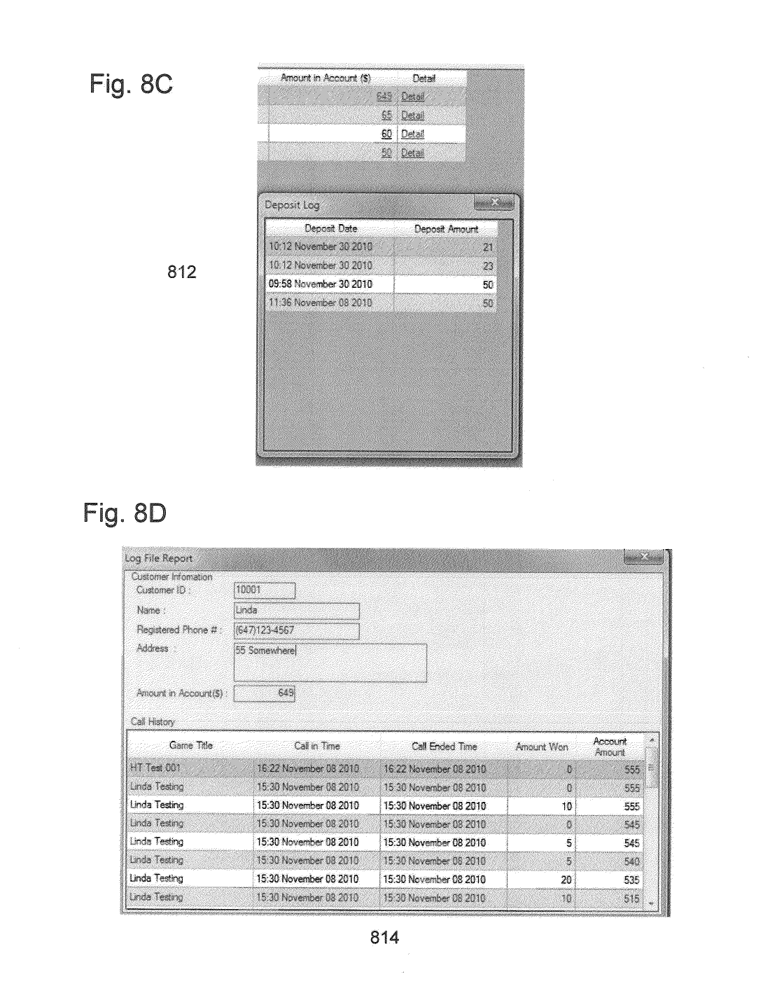

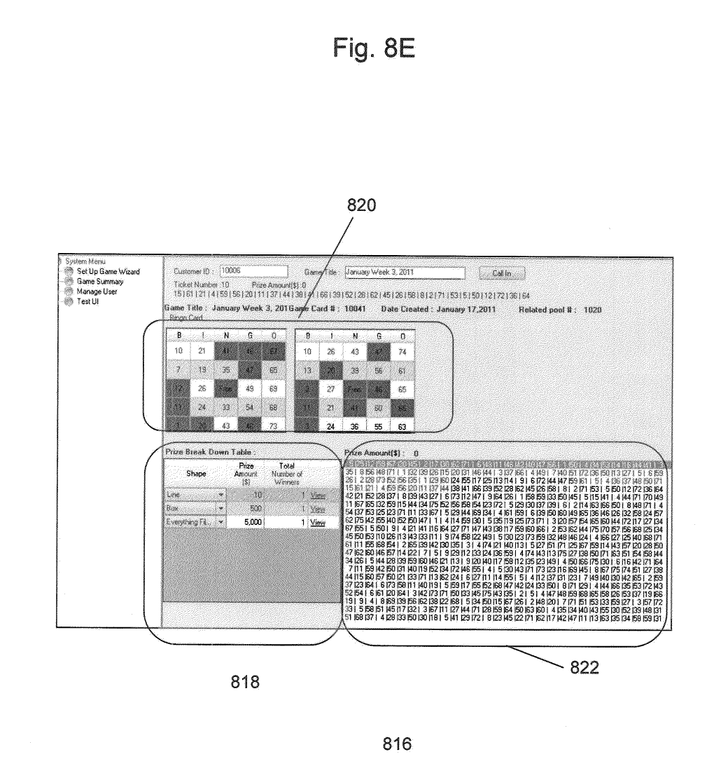

Referring to FIGS. 7 and 8a-8e, aspects of processes executed by admin. app. 608 operating on server 108 are provided as shown generally in process 700, shown in FIG. 7 producing exemplary GUIs, shown in FIGS. 8a-8e. Details are provided on processes of admin. app. 608 that facilitate establishment, configuration, tracking and management of a game, its game cards, its sets of numbers, its odds, its prizes, accounting for game sessions and other features of the game. Admin. app. 608 generates a set of GUIs as a “set-up wizard” process that allows an administrator to set up and configure aspects of a game and game sessions.

At process 702, admin. app. 608 on server 108 is activated. In one embodiment, the admin. app. provides a series of GUIs for review by a game administrator, having access directly to server 108 or through a remote access to server 108. Admin. app. 608 in one embodiment is accessed through a voice call initiated at device 104 for a particular game session. Admin. app. 608 and can track multiple calls, multiple game sessions for a pool (from different devices) and multiple game pools simultaneously. Some aspects of admin. app. 608 may be executed offline with its devices 104.

At process 704, a series of GUIs are generated providing the administrator with options and interfaces for designing specific game pools, setting winning condition and prizes for the pools. At process 706, as parameters are entered through the GUIs, number sets are generated for a game pool and parameters are saved to server 108. At process 708, a loop is provided for the administrator to enter/change more parameters or save the final parameters for a game and game sessions to server 108. If more parameters are to be changed/entered, process 700 returns to process 704. If all changes are entered, process 700 moves to end process 710. Aspects of process 700 may be restricted to changes (e.g. winning conditions, odds, etc.) once the pool is “finalized” and released for “live” play sessions by users.

Further detail is now provided on GUIs and specific configuration features provided by admin. app. 608.

As an initial configuration process for a new game, a series of GUIs are provided to allow the administrator to input basic features of a card and the game, including a title for the game, the quantity of cards for the pool.

In FIG. 8a, GUI 800 shows a screen that allows an administrator to link a game to a new game pool, if desired. A GUI provides a screen to enter the total number of sessions, allowing the administrator to provide parameters for the total number of sets of numbers for a pool to be generated and configurations and allocations of patterns and conditions for prizes.

In FIG. 8b, GUI 802 provides details of games and prize amounts for game sessions executed by the game application in server 108 in a game administration screen. GUI 802 shows four exemplary GUIs where parameters of a game pool are displayed as a result of changes/inquiries provided through admin. app. 608, including facilities to: view a generated playing card; search previous games; print a playing card (for release to a newspaper); view a prize table and prize shapes for a game; and view number pool information. GUI 804 shows a prize table where various parameters and winning conditions for a game have been set. GUI 806 shows exemplary game cards generated by the system once game parameters are set. Visual cues, such as colours and shadings, on the cards provide information about each square. For example, a square having a first background colour (e.g. “red”), shows that the square is in the set of numbers generated by an embodiment that will be (or have been) and provided to the player during a game session by the system. As shown in GUI 806, two game cards being played are shown that currently have non-winning conditions. GUI 808 shows a set of numbers that were generated by an embodiment that are the current numbers being played for a game for the two cards in shown in GUI 806. As a number in the set is “called”, the corresponding square for a card in GUI 806 is marked in the first background colour (here, red).

GUI 808 shows a list of sets of numbers that can be played in a pool for a game. The pool for a game may span several days, weeks, issues of newspapers, magazines, etc. As such there may be N individual sets of numbers for N game sessions in a pool. For a game, such as Bingo, all results can be deterministic or randomly generated. In a deterministic setting, the layout of a card for a pool is predetermined and the sets of numbers for the pool are also predetermined. As such, the sets of numbers can be populated with predetermined winning conditions for the card in the pool. Randomness may introduced into the game sessions by randomly choosing among the sets of numbers, based on specific seed data for desired probabilities of winning.

The game prizes can be defined by the prize amounts set by the administrator. For example, if a game pool is provided with one grand prize of $10,000 and the total session size is 500 plays of the game, then the odds of winning the grand prize as 1 in 20 for the pool. In a Bingo game, a certain number of sets of numbers can be provided that have one (or more) of exemplary winning conditions for a given playing card: one or more complete rows, one or more complete columns, an X pattern, an H pattern, a blackout pattern, four corners of the game card, etc. For each winning condition, parameters allow server 108 to set the exact number of sets of numbers that will satisfy each winning condition for a given card. The sets of numbers can be generated such that there is only one set that has the winning set of numbers for the grand prize. Similar calculations and card layouts can be provided for other prizes.

In defining parameters for a pool, an administrator initially determines how many sets of numbers (“N”) will be in the pool. A set generating algorithm generates a Bingo card and then generates sets of numbers that will be playable for that card, preferably such that two plays have exactly duplicated numbers. The card and the sets of numbers can be generated using deterministic or random methods. The number of sets of numbers that contain “winning” layouts should match odds of winning as established as a parameter for the game session. The sets of numbers can also be designed so that no session provides multiple winning number combinations for the given card. For tracking purposes, the card is assigned and tracked by a game number.

GUI 810 shows a portion of details of the sets of numbers in the pool from 1 to 8 (for a total pool of X numbers), the prize associated with each number set, a status of the set (i.e. whether it has been “Selected” or used by a player), a game card number and a game title.

When parameters for the winning conditions are set in GUI 804, the system can then generate a game card and sets of numbers for the pool that follow the winning parameters. For example, per FIG. 2, a game card can be generated that has a layout of squares of a Bingo card with squares 202a, which are to be filed during the game play. The values of each square can be determined from a square generator that randomizes, in part at least, the numbers provided for the squares and whether the squares are pre-filled or not. In one embodiment, when a particular game session is selected to be applied against that card, the set of numbers for the sessions has been selected from the sets of previously generated numbers. As such, the set of numbers can be immediately applied against the squares of the card. Where the numbers in the set match the squares in the card, those matching squares are noted in a different colour, per squares 202b. As such for the administrator, there is an immediate visual indication of the results of the game play for that session for that set of numbers.

Further detail is provided on generation of values for numbers of a Bingo card and sets of numbers for a pool. As noted earlier, one parameter in determining the sets of numbers is the total number of sets of numbers that win prizes for games using the card. Parameters provided in GUI 804 and others provide a macroscopic view of the total number of prizes that can be awarded at a maximum for a full play of all possibilities for a game. As such, the administrator can set and control the maximum payout for any game.

Once the parameters are set, the embodiment then calculates odds for each winning condition as defined in GUI 804. For each winning condition, the embodiment can generate a set of numbers that includes numbers for the winning condition and pad the remaining numbers with values that do not trigger any more (or any less) winning conditions.

For example, referring to FIG. 2, if the administrator sets in a prize table that an “X” in a card is a winning condition and that there are to be two winning sets of numbers for the “X”, then once the layout of card 200 is set, the algorithm can identify and generates two sets of numbers in the game pool that would complete an “X” pattern on the card, namely two sets having the numbers B-1; B-15, I-23, I-28, G-49, G-53, O-61 and O-74 for the squares. The algorithm will populate the remaining 22 numbers with numbers that do not complete other winning patterns for the game. For example, the numbers I-29, N-42 and G-60 would all not be provided in the set as those numbers with B-15 and O-74 would complete a horizontal line, as a second winning condition. The order and location of the five (5) winning numbers can be distributed randomly within the set of numbers. For the second set of winning numbers, the five (5) winning numbers can again be distributed randomly within that second set of numbers. Similar sets of numbers can be generated for other winning conditions. As each set of numbers is generated, it is stored by the system. A field associated with each set can hold flags associated with the values for the set, including flags indicating whether the set has been selected, the account associated with the user that the set is provided to during a session, whether the set is a winning set and if so, for what combination, the position of the last number in the set that completes a winning condition and others.

When the game pool is set (with the sets of numbers and the layout of the card defined), before the game pool is released to the public, the layout of the card must be distributed to the general audience. In one embodiment, the card is provided to printed publications (e.g. newspapers or magazines) or on product wrappers (e.g. for candy bars). Electronic versions of the card may also be made available (e.g. through a web site). Enough lead time is needed to have the cards printed on the proper substrates and distributed before the game can be activated.

Once all sets of numbers have been generated, the system then has a matrix of sets of numbers that represent the pool of numbers played for the associated card. When a game session for the card is initiated (per FIGS. 4 and 5), the device initiating the game session is provided with one set of the sets of numbers in the pool on a random or pseudo-random basis. Once the set is selected, its parameters for its flags are updated and the system calls out each number in the set of the device (as noted before) for the session.

FIG. 8c shows GUI 812 providing a summary of an account for a player of a game session, showing deposits made to the account when a player has played the Bingo game and has won.

In FIG. 8d, GUI 814 provides a summary of calls made by a user of device 104 in accessing the game application in server 108.

While the above noted pool describes one game card played by multiple game sessions in a single game pool, in other embodiments, multiple game cards can be provided for a game pool.

Referring to FIG. 8e, GUI 816 shows exemplary details of games and prize amounts for game sessions executed by the game application in server 108. As noted above, prize amounts are generated at the beginning when the administrator defines the pool. While a given game card and the sets of numbers for plays of the game are preset, the allocation of a specific card and/or specific set of numbers to a player are provided on a random basis. GUI 818 shows a prize table where various parameters and winning conditions for a game have been set for the test run based on the parameters provided. GUI 820 shows game cards generated by the system once game parameters are set. GUI 822 shows rows of sets of numbers that have been generated/selected in the various simulations for this test run.

An embodiment provides a “test mode” for testing the parameters of a game, to initiate a “test run” of a game play using those parameters. An embodiment will simulate a call-in event and generate the ticket number, prize amount, game title, game card number, date code, related pool, bingo card, prize break down table and the random numbers that generate the shape. Once the administrator is satisfied with the operation of a test run, the parameters for a game can be set. Thereafter, the administrator can allows server 108 to release the game “live” to players at devices 104, where IVR app. 606 is then permitted to process “live” calls and process “live” game plays.

Other GUIs and functions in admin. app. 608 provide facilities for an administrator to validate users and their accounts, call up a current status report of a game in session, provide details on prizes allocated, won and outstanding for a pool, number of prizes available to be won for each prize category, amounts of each prize, total number of winners for each prize type and others.

An embodiment also generates and provides game session summary reports to other systems. As noted before, one revenue stream for the game is the airtime (i.e. network connection time) consumed by device 104 while its user is playing the game session. Server 108 may be operated by a game operator, but network 112 providing the data/voice services for the sessions provides the infrastructure to carry the calls initiated over network 112 for the game sessions. As such, a payment scheme can be established between the operator of server 108 and the operator of network 112, wherein the operator of server 108 provides records of time and data usage of its players of its games over network 112. These can include a cumulative report of the connection times for all game sessions and may include roaming and long distance fees associated with the sessions. All of the connection and roaming fees are charges that operator of network 112 may be billing to accounts associated with the played game sessions. Such charges would not have been incurred without the hosting of the game. As such, the operator of server 108 may have an agreement with the operator of network 112 to charge a royalty fee or other fee payable by the operator of network 112 to the operator of server 108 based on the total connection, roaming and data charges associated with the played game sessions over network 112. As a secondary revenue stream, the operator of server 108 may also charge a fee to the publications carrying the game cards, as playing of the game cards requires the users to buy the carrying publication.

As an alternative implementation, another embodiment provides a “server/client” implementation of the gaming application where a client-side gaming application operating on device 104 communicates with server-side application operating on server 108 perform functions described in processes noted above. In this alternative embodiment, data and messages may be exchanged between device 104 and server 108 through a data communication channel.

It will be appreciated that the modules, processes and other applications in the embodiments can be implemented using known programming techniques, languages and algorithms. The titles of the modules are provided as a convenience to provide labels and assign functions to certain modules. It is not required that each module perform only its functions as described above. As such, specific functionalities for each application may be moved between applications or separated into different applications and different devices (e.g. between the server and the devices accessing the server). Modules may be contained within other modules. Different signaling techniques may be used to communicate information between applications using known programming techniques. Known data storage, access and update algorithms allow data to be shared between applications.

As used herein, the wording “and/or” is intended to represent an inclusive-or. That is, “X and/or Y” is intended to mean X or Y or both.

The present embodiment is defined by the claims appended hereto, with the foregoing description being merely illustrative of embodiments of the present disclosure. Those of ordinary skill may envisage certain modifications to the foregoing embodiments, which although not explicitly discussed herein, do not depart from the scope of the disclosure, as defined by the appended claims.

1. A system for executing an instance of a game having a playing card in a game session of a plurality of game sessions in a game pool on a communication device through a network, the system comprising:
a server for managing execution of the game session for the communication device, the server
evaluating credentials and restrictions of an account associated with the game and with a user of the communication device;
providing a set of tokens having values to be played for the game session against the playing card;
tracking winning conditions for the game session as the set of tokens is played in the game session;
tracking a log time for the game session for the communication device; and
generating a report of the log time when the game session is completed at the communication device,
and
a database for storing and updating a record of the game session and the account.

2. The system for executing an instance of a game as claimed in claim 1, wherein the server sequentially provides tokens from the set of tokens to the communication device for the game session.

3. The system for executing an instance of a game as claimed in claim 1 or claim 2, wherein:
the playing card is distributed through a publication as a printed playing card.

4. The system for executing an instance of a game as claimed in claim 3, wherein:
the playing card is further distributed in an advertisement.

5. The system for executing an instance of a game as claimed in claim 3 or claim 4, wherein:
the game is Bingo;
the values for the set of tokens are randomly generated numbers; and
the playing card is a Bingo card with numbers to be filled by the generated numbers.

6. The system for executing an instance of a game as claimed in claim 3 or claim 4, wherein:
the game is a crossword;
the values for the set of tokens are randomly generated letters; and
the playing card is a crossword card with letters to be filled by the generated letters.

7. The system for executing an instance of a game as claimed in claim 3 or claim 4, wherein:
the game is a tic-tac-toe;
the values for the set of tokens are randomly generated X's and O's; and
the playing card is a tic-tac-toe card with spaces to be filled by the generated X's and O's.

8. The system for executing an instance of a game as claimed in any one of claims 1 to 7, wherein:
the log time is used to track a charge associated with the game session for the account; and
the network is a voice communication network.

9. The system for executing an instance of a game as claimed in any one of claims 1 to 8, wherein the server further:
generates a graphical user interface (GUI) for entry of game parameters for an administrator of the game, the parameters including templates for the winning conditions; and
generates numbers for the playing card, the set of tokens and other sets of tokens for the game pool using parameters of the winning conditions.

10. The system for executing an instance of a game as claimed in claim 9, wherein:
the set of tokens and the other sets of tokens for the game pool are generated prior to the start of the game.

11. The system for executing an instance of a game as claimed in any one of claims 1 to 10, wherein:
a winning condition of the winning conditions is completion of a pattern in the playing card by numbers or letters in the set of tokens.

12. The system for executing an instance of a game as claimed in any one of claims 1 to 11, wherein:
the set of tokens is selected from the plurality of sets of tokens on a random basis.

13. The system for executing an instance of a game as claimed in any one of claims 1 to 12, wherein the server further:
generates a text message to provide the set of tokens to the communication device.

14. The system for executing an instance of a game as claimed in any one of claims 1 to 13, wherein the server further:
sends a message to the communication device providing details on the set of tokens to allow the communication device to generate an image of the set of tokens on a display of the communication device.

15. The system for executing an instance of a game as claimed in any one of claims 1 to 14, wherein the database further:
tracks points associated with the game session in a loyalty point database for the account.

16. The system for executing an instance of a game as claimed in any one of claims 1 to 14, wherein:
the playing card is a common playing card used by a plurality of players.

17. A method for executing an instance of a game having a playing card in a game session of a plurality of game sessions in a game pool on a communication device through a network, the method comprising:
in a server for managing execution of the game session for the communication device, the server
evaluating credentials and restrictions of an account associated with the game and with a user of the communication device;
providing a set of tokens having values to be played for the game session against the playing card;
tracking winning conditions for the game session as the set of tokens is played in the game session;
tracking a log time for the game session for the communication device; and
generating a report of the log time when the game session is completed at the communication device,
and
storing and updating a record of the game session and the account.

18. The method for executing an instance of a game as claimed in claim 17, wherein:
the playing card is distributed through a publication as a printed playing card.

19. The method for executing an instance of a game as claimed in claim 18, wherein the playing card is further distributed in an advertisement.

20. The method for executing an instance of a game as claimed in claim 17 or claim 18, wherein:
the game is Bingo;
the values for the set of tokens are randomly generated numbers; and
the playing card is a Bingo card with numbers to be filled by the generated numbers.
